(19) United States
(12) Patent Application Publication
(10) Pub. No.: US 2008/0127495 A1
(43) Pub. Date: Jun. 5, 2008

(54) Pre-honed doctor blade with a curved profile lamella and method for producing said doctor blade

(75) Inventors: Alberto Filippini Fantoni, Milano (IT); Sveva Filippini Fantoni, Milano (IT); Uberto Filippini Fantoni, Milano (IT)

Correspondence Address: NIXON & VANDERHYE, PC, 901 NORTH GLEBE ROAD, 11TH FLOOR, ARLINGTON, VA, 22203, US

(73) Assignee: C.B.G. Acciai S.r.l., Caronno Pertusella (VA) (IT)

(21) Appl. No.: 11/812,302

(22) Filed: Jun. 18, 2007

(30) Foreign Application Priority Data
Dec. 4, 2006 (EP) 06 425 818.9

(51) Int. Cl. B23D 79/02; B23P 15/44

(52) U.S. Cl. 30/169; 29/557

(57) ABSTRACT

A pre-honed doctor blade (1) with a lamella profile (2), produced by means of a grinding wheel (3), wherein the lamella (2) has a curved profile (shaped as an arc of a circle or as an arc of an ellipse) and the manufacturing grooves (4) produced by the grinding wheel (3) on the lamella (2) are not parallel to the edge of the doctor blade (1).

A method of producing said doctor blade (1) is also described, comprising at least the steps of:

positioning above the band a grinding wheel (3) with its axis of rotation not at right angles to the edge of the doctor blade (1);

setting the grinding wheel (3) in rotation;

moving the band beneath the grinding wheel (3) parallel to its edge.

The grinding wheel 3 can be a cylindrical grinding wheel or a conical grinding wheel; during the processing, the edge of the doctor blade (1) can be maintained on the vertical drawn from the centre of the grinding wheel (3) or offset with respect to said vertical.

The present invention refers to a pre-honed doctor blade with a curved profile lamella and to a method for producing said doctor blade

Doctor blades are well-known devices normally used to detach from a cylindrical surface with a finite (cylinder) or infinite radius (flat surface) a product (in liquid, paste or powder form) previously adhering to said surface. Doctor blades can therefore be used in many sectors to clean the surface of cylinders used (for example) for printing, to distribute and to spread glues, for grinding, etc

In many printing methods doctor blades are used to distribute the printing ink on a frame (as, for example, in screen printing) or to remove the excess ink from a printing cylinder (rotary printing, flexographic printing, etc.) or from a flat cliché (letterpress printing, tampography).

With particular reference to the printing presses, a doctor blade operates in direct contact with the surface of the print cylinder to eliminate the printing ink from the unengraved parts of said surface and the excess printing ink from the engraved parts of said surface; both the surface of the printing cylinder and the doctor blade are therefore subject to wear since the speed of rotation is high. Consequently, the printing cylinders are often coated with a layer of hard material (for example ceramic material or hard chromium), which can differ according to specific applications.

The doctor blades for printing presses currently in use consist mainly of a metal support consisting in a precision steel band, cold rolled and tempered.

In the presence of corrosion phenomena or, in general, for applications where a high resistance to the abrasion and to the wear is required, the metal support can consist of a stainless martensitic steel band or of a band of low-alloy steel with various additives.

In order to improve the resistance to wear of the doctor blade-cylinder assembly, the metal support is often totally or partially coated along the edge(s) with coating layers of various types: thin metal layers (for example chrome or nickel plating), layers of ceramic material, of polymer material, etc., deposited by known processes.

Doctor blades consisting entirely of synthetic materials to improve their adhesion to the surface of the cylinder and to reduce the wear on said cylinder are also known to the art.

In all the cases described above, one or both of the straight edges destined to come into contact with the surface of the print cylinder has the profile considered most advantageous on a case-by-case basis to meet specific needs.

The doctor blade-cylinder contact edge of the doctor blades currently known to the art has one of the following profiles:

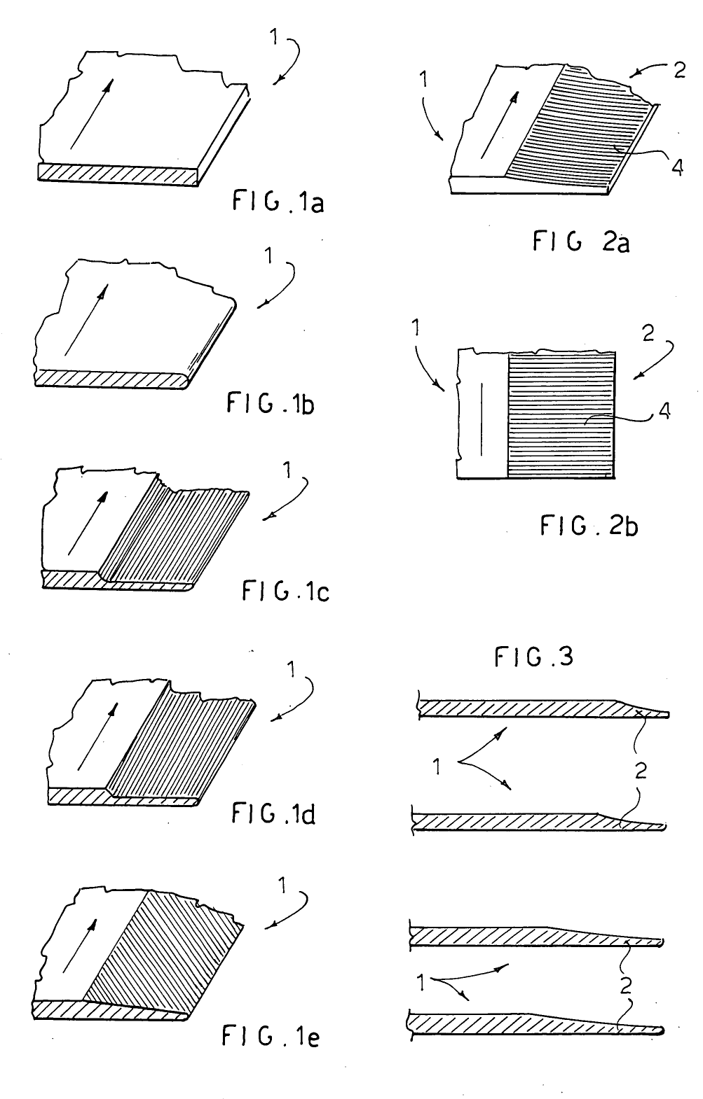

rectangular profile: full thickness doctor blade, doctor blade-cylinder contact edge not pre-honed with 90° sharp edges sheared, de-burred or ground (FIG. 1a);

rounded profile: full thickness doctor blade, doctor blade-cylinder contact edge not pre-honed and with radial edges (FIG. 1b);

bevel profile: doctor blade-cylinder contact edge pre-honed at an angle, with the thickness of the bevel increasing linearly from the tip of said bevel to where it joins the doctor blade body; the tip of the bevel may or may not be rounded (FIG. 1e).

lamella profile: doctor blade-cylinder contact edge pre-honed, with a minimum change in thickness along the lamella from the tip of said lamella to where it joins the doctor blade body; the tip of the lamella may or may not be rounded (FIGS. 1c and 1d).

With reference to the lamella profile, in order to obtain the thin lamella with a constant or semi-constant thickness, the edge thereof is thinned longitudinally with a tangential grinding method or with the use of cup grinding wheels; since—in the known manufacturing methods for producing a lamella profile—the axis of rotation of the grinding wheel is substantially at right angles to the edge of the doctor blade, the manufacturing grooves are substantially longitudinal, that is substantially parallel to the edge of the doctor blade.

If the grinding wheel is tangential, its axis of rotation is at right angles to the edge of the doctor blade and parallel to the plane of the doctor blade and the manufacturing grooves are parallel to the edge of the doctor blade (FIG. 1c); if the grinding wheel is a cup grinding wheel, its axis of rotation is substantially at right angles to the edge of the doctor blade and to the plane of the doctor blade and the processing grooves are almost parallel to the edge of the doctor blade (FIG. 1d).

The geometry of each profile is chosen on a case-by-case basis, in per se known manner, according to the type of process (rotary printing, flexographic printing, tampographic printing, spreading, etc.) and, within the same process, on the basis of the parameters that govern said process, amongst which are: type and hardness of the cylinder, type of engraving, speed of rotation of the cylinder, type and density of the ink, pressure applied, etc.

The object is to ensure the best doctoring the possible, that is, with particular reference to the printing processes, the best regulation possible of the amount of ink that fills the cells of the cylinder engravings. This turns off into the search for the best compromise between length of print run, evenness of tone for the whole duration of the print run and absence of printing faults such as streaks, smears etc.

The non pre-honed contact edge, which makes the doctor blade usable from both sides without distinction, finds its main application in flexographic printing where at the relatively greater thickness of the blade, in combination with the characteristics of the print process, allows a good doctoring of the anilox cylinders; the non pre-honed doctor blade is also used as the closing doctor blade in the inking chamber.

The pre-honed contact edge with a lamella tip has the following advantageous characteristics:

adaptability to the cylinder: it allows an excellent doctoring even the presence of cylinders with very high line counts and low printing pressures;

flexibility: the reduced thickness of the lamella with respect to the more robust blade body allows limited working pressures even at high speeds and, consequently, leads to an increase in the life of the blade and thus of the print run;

evenness of wear on the lamella: as a result there is a good continuity of tone throughout the print run;

and the following unfavourable characteristics:

because of the longitudinal manufacturing grooves, during wear on the blade long threads of the material making up the doctor blade tend to form at the deepest grooves and at the highest ridges; these threads can cause printing flaws or damage the doctor blade itself, the printing ink filters or other accessory equipment such as pumps, etc.;

because of the sudden change of thickness due to be short join between the lamella and the doctor blade body and to the critical nature of the manufacturing at the point of joining, the elasticity of the doctor blade changes sharply in the joining area: this leads to the risk of breakage and/or of permanent bending of the doctor blade at the joining area, etc.;

the actual working angle varies greatly according to even minimal changes in pressure because of the weakness of the lamella at the point of joining.

The pre-honed bevel contact edge, on the other hand should ensure a more even reaction to the pressure applied. The angled bevels obtained with a cup grinding wheel have inclined manufacturing groves with respect to the edge of the blade but have a linearly increasing thickness, which compromises the evenness of the doctoring because of the wear on the edge, with a resulting variation in tone.

In the case of a rounded tip of the lamella or of the bevel, the running-in time of the doctor blade is reduced to a minimum.

A combination of a plurality of profiles is also possible: for example, doctor blades are known to the art which have an contact edge with the cylinder of variable thickness, with the full thickness ends and the pre-honed central part with a lamella, with the main purpose of reducing the wear on the doctor blade at the edges of the cylinder during the oscillation of the blade.

By reducing the risk of breakage of the blade at the edges of the cylinder and the consequent leakage of ink, a lengthening of the duration of the blade and thus of the print run is obtained, other parameters being equal.

None of the doctor blades currently in use has proved able to satisfy fully the requirements of users. In fact, it is rather frequent to find that the following problems persist:

fragility of the lamella or of the bevel;

rapid wear of the doctor blade-cylinder assembly in the case of high printing pressure and/or of high speeds and/or of long print runs.

uneven wear on the doctor blade/print cylinder assembly, which leads to a lack of continuity of tone, to hazing, to streaks and/or to other faults;

formation of threads of the material forming the doctor blade due to wear on said doctor blade.

Object of the present invention is to produce a doctor blade suitable to overcome the above drawbacks presented by the doctor blades of the prior art; this object is achieved by means of the doctor blade which has the characterising elements illustrated in claim 1, produced by means of the method illustrated in claim 10.

Further advantageous characteristics of the invention form the subject matter of the dependent claims.

Exemplifying embodiments of the invention will be described hereunder, purely by way of non-limiting illustration, with reference to the appended figures, in which:

FIG. 1 shows diagrammatically, in a perspective view, the terminal area of some known types of doctor blade;

FIG. 2 shows diagrammatically a perspective view and a top view of the terminal part of a doctor blade forming the subject matter of the present invention;

FIG. 3 shows diagrammatically the side views of some doctor blades forming the subject matter of the present invention;

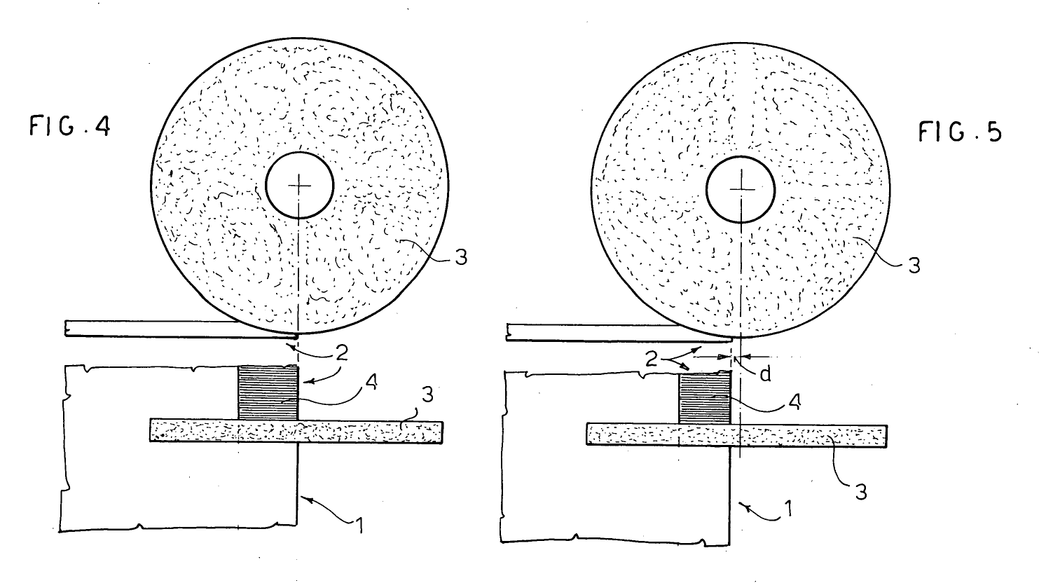

FIG. 4 shows diagrammatically a side view and a top view of a doctor blade during manufacturing according to a first embodiment of the method forming the subject matter of the present invention;

FIG. 5 shows diagrammatically a side view and a top view of a variant of the method of FIG. 4;

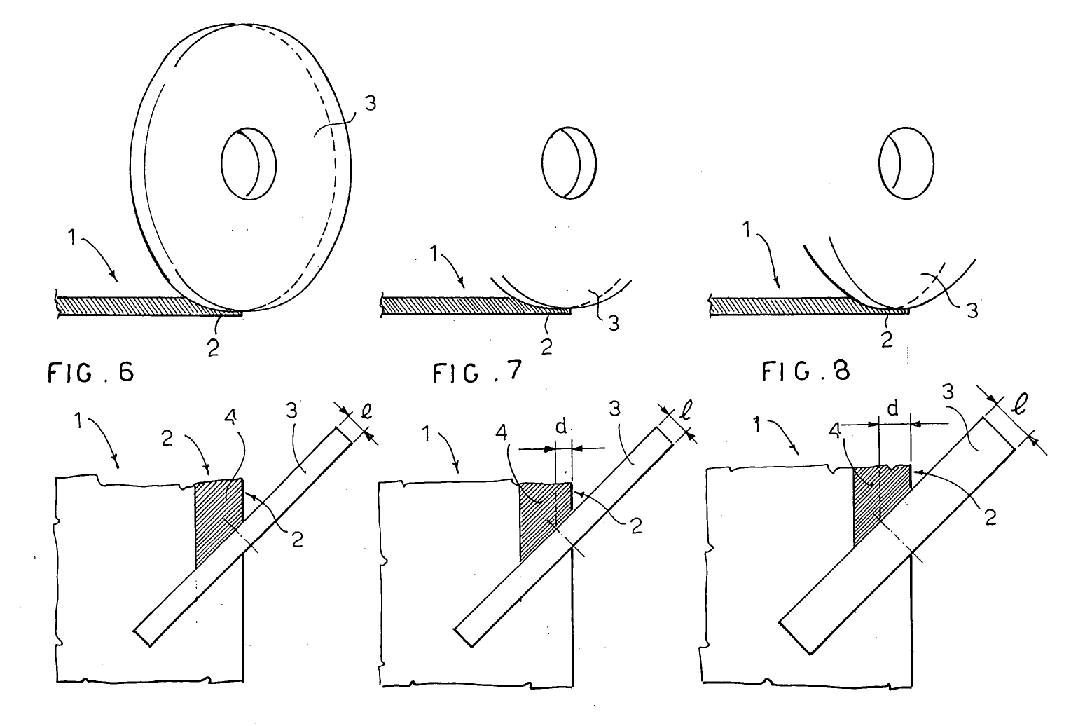

FIG. 6 shows diagrammatically a side view and a top view of a doctor blade during manufacturing according to a second embodiment of the method forming the subject matter of the present invention;

FIGS. 7 and 8 show diagrammatically a side view and a top view of some variants of the method of FIG. 6;

In the appended figures like elements will be designated by the same reference numerals.

The present invention refers to a pre-honed doctor blade with a lamella profile, produced by means of a grinding wheel, wherein the lamella has a curved profile and the manufacturing grooves produced by the grinding wheel on the lamella are not parallel to the edge of the doctor blade.

A method of producing the above-mentioned doctor blade—starting from a band—also forms the subject matter of the present invention and comprises at least the steps of.

positioning above the band a grinding wheel with its axis of rotation not at right angles to the edge of the doctor blade;

setting the grinding wheel in rotation; and

causing the band to move beneath the grinding wheel parallel to its edge.

With reference to FIGS. from 2 to 8, the doctor blade/print cylinder contact edge of a doctor blade 1 according to the present invention consists of a lamella 2 with a curved profile obtained by means of a grinding wheel 3 having its axis of rotation not at right angles to the edge of the doctor blade 1, so that the lamella 2 with a curved profile is obtained by removal of material in a right-angled or in a oblique direction with respect to the edge of the doctor blade 1.

The grinding wheel 3 can be a disk grinding wheel or a conical grinding wheel and its axis of rotation can be parallel to the edge of the doctor blade 1 (FIGS. 4 and 5) to produce a lamella 2 having a profile shaped as an arc of a circle, or inclined with respect to the edge of the doctor blade 1 (FIGS. 6-8) to form a lamella 2 having a profile shaped as an arc of an ellipse, the initial portion of which, for the part resembling a straight line, has a profile having an inclination between 0° and 3°, preferably between 1.2° and 2.2°.

If the axis of rotation of the grinding wheel 3 is parallel to the edge of the doctor blade 1 (FIGS. 4 and 5) the doctor blade 1 has grooves 4 due to machining of the lamella 2 at right angles with respect to the edge of the doctor blade 1 (FIGS. 2, 4 and 5) whilst if the axis of rotation of the grinding wheel 3 is inclined with respect to the edge of the doctor blade 1 (FIGS. 6-8) the machining grooves 4 are inclined with respect to the edge of the doctor blade 1 by an angle equal to the angle of inclination of the axis of rotation of the grinding wheel 3 with respect to the edge of said doctor blade.

The doctor blade according to the present invention, in which the machining grooves 4 are at right angles or inclined with respect to the edge of the doctor blade 1, advantageously has a greater resistance to the bending and a more even wear on the lamella: the possibility that threads of the material making up the doctor blade, which could cause print defects, might be formed along the doctor blade/cylinder contact edge is thus drastically reduced (or completely eliminated).

The lamella 2 with a curved profile produced according to the invention preferably has a width of between 1.50 and 5.00 millimetres and its honed end has a thickness between 0.055 mm and 0.120 mm.

Purely by way of example, if the doctor blade 1 has a thickness of 0.152 mm, the lamella 2 has a width of 2.28 mm and its honed edge has a thickness of 0.065 mm.

The above-mentioned proportions make it possible to work with limited pressures even at high speeds and in any case with lower pressures, other parameters being equal, compared with those necessary with the use of a doctor blade with a pre-honed lamella of the traditional type. Therefore, the life of the doctor blade and consequently the duration and the continuity of the print run are increased.

FIG. 3 shows diagrammatically the side views of four doctor blades 1 according to the present invention, whose curved lamellas 2 are of different lengths (and therefore of different flexibilities) to meet specific requirements of use. The different profiles of the doctor blades 1 are obtained by choosing appropriately the diameter, the thickness and the position of the grinding wheel 3, as will be illustrated hereunder with reference to FIGS. 4-8.

The thickness of the lamella 2 is advantageously almost constant for about 1 mm starting from the honed end and then increases quadratically along the remaining portion of the lamella 2 up to the area of joining with the body of the doctor blade 1.

Such a profile of the blade 2 has been obtained experimentally to allow an evenness of the specific pressure according to wear on the blade. As a result there is a good continuity of tone throughout the print run and an almost complete absence of hazing.

Repeated careful tests performed by the applicant have shown that, operating conditions being equal, the consumption of a doctor blade produced according to the invention is about 30% less than that of the doctor blade according to the prior art having the best performance.

The method according to the present invention to obtain—starting from a band—a doctor blade 1 having the curved lamella 2, will now be described with reference to FIGS. 4 to 8 which showed diagrammatically a side view and a top view of doctor blades being produced according to some embodiments of the aforementioned method.

In FIGS. 4 to 8 the grinding wheel 3 is a disk grinding wheel (not described because it is per se known) having its axis of rotation not at right angles with respect to the edge of the doctor blade 1 but, without departing from the scope of the invention, the grinding wheel 3 can be a conical grinding wheel whose axis of rotation, not at right angles to the edge of the doctor blade 1, has an inclination equal to the taper of the grinding wheel 3; a conical grinding wheel creates a more progressive removal of material and reduces the heating, the mechanical stresses and the relative deformation.

The profile of the lamella 2 produced according to the invention can be shaped as an arc of a circle or as an arc of an ellipse, according to whether the axis of rotation of the grinding wheel 3 is parallel to the edge of the doctor blade 1 or inclined with respect to the edge of the doctor blade 1 by an angle between 0° and 85°, preferably between 0° and 45°.

In the first case the grooves are at right angles with respect to the edge of the doctor blade 1, in the second case the grooves are incident to the edge of the doctor blade 1 with an angle equal to the inclination of the axis of rotation of the grinding wheel 3 with respect to the edge of the doctor blade 1; in both cases the advantage of avoiding the formation of threads due to wear during use remains.

Furthermore, the profile of the blade shaped as an arc of a circle or as an arc of an ellipse can be obtained by operating with the edge of the band on the vertical taken from the centre of the grinding wheel 3 (FIGS. 4 and 6) or by operating with the edge of the band offset with respect to the vertical drawn from the centre of the grinding wheel 3 (FIGS. 5, 7 e 8).

This offset d (FIGS. 5, 7 and 8) presents the advantage of allowing the width of the lamella 2 and the thickness l of its edge to be varied (the diameter of the grinding wheel 3 and, if inclined, the thickness thereof remaining equal) without having to replace the grinding wheel 3 or to move it vertically to bring it nearer to or further from the doctor blade 1.

With a disk grinding wheel 3 having a thickness l and the axis inclined with respect to the edge of the doctor blade 1 by an angle α (α≠0), the offset d is preferably such as to create a lamella 2 having a flat portion with the width p (not shown in the figures for the sake of simplicity of the graphic representation) comprised between 0 mm and 1.5 mm.

The width p of the flat portion varies from a minimum of 0.5*l*sen a (for d=0) to a maximum of l*seen a (for d=p/2, when the whole thickness l of the grinding wheel is exploited)

With a disk grinding wheel 3 with a radius r and axis parallel to the edge of the doctor blade 1 (α=0), the flat portion has a width p=0, irrespective of the offset d, which is comprised between 0 and 0.05*r, preferably 0.03*r.

With a disk grinding wheel 3 with its axis inclined with respect to the edge of the doctor blade 1, other conditions being equal,

a greater offset d means that the portion of the profile of the lamella 2 assimilable to a rectilinear portion is longer, as can be seen by comparing the blades 2 shown in FIGS. 6 and 7;

using a grinding wheel 3 with a greater thickness it is possible to obtain a wider lamella 2, as can be seen by comparing the blades 2 shown in FIGS. 7 and 8.

The use of a disk grinding wheel with a larger or smaller diameter makes it possible to obtain profiles nearer to that theoretically desired for each specific application related to a higher or lower printing speed, density and/or type of think, greater or lesser density of engraving etc.

A person skilled in the art can make to the doctor blade and to the manufacturing method previously described all the modifications and the improvements suggested by the normal experience and/or by the natural evolution of the art without departing from the scope of the invention.

1. A pre-honed doctor blade with a lamella profile, produced by means of a grinding wheel, characterised in that the lamella has a curved profile and in that the machining grooves produced by the grinding wheel on the lamella are not parallel to the edge of the doctor blade.

2. A doctor blade as in the claim 1, characterised in that the lamella has a profile shaped as an arc of a circle.

3. A doctor blade as in the claim 1, characterised in that the lamella has a profile shaped as an arc of an ellipse.

4. A doctor blade as in the claim 1, characterised in that the lamella has a width between 1.50 mm and 5.00 mm and a thickness (measured at the tip) between 0.055 mm and 0.120 mm.

5. A doctor blade as in the claim 4 wherein the doctor blade has a width of 0.152 mm, characterised in that the lamella has a width of 2.28 mm and its honed end has a thickness of 0.065 mm.

6. A doctor blade as in claim 1, characterised in that the thickness of the initial portion of the lamella is constant for about 1 mm starting from the honed end and increases quadratically along the remaining portion of the lamella up to the area of joining with the body of the doctor blade.

7. A doctor blade as in the claim 3, characterised in that the initial portion of the lamella has an inclination comprised between 0° and 3°.

8. A doctor blade as in the claim 7, characterised in that the initial portion of the lamella has an inclination comprised between 1.2° and 2.2°.

9. A doctor blade as in the claim 3, characterised in that the lamella has a flat portion with a width (p) between 0 mm and 1.5 mm.

10. A method for producing, starting from a band, a doctor blade as in claim 1, characterised in that it comprises at least the steps of:
positioning above the band a grinding wheel with its axis of rotation not at right angles to the edge of the doctor blade;
setting the grinding wheel in rotation;
moving the band beneath the grinding wheel parallel to its edge.

11. A method as in claim 10, characterised in that the grinding wheel is a disk grinding wheel.

12. A method as in claim 10, characterised in that the grinding wheel is a conical grinding wheel with its axis of rotation having an inclination equal to the taper of the grinding wheel.

13. A method, for producing starting from a band, a doctor blade as in claim 2, characterised in that it comprises at least the steps of:
positioning above the band a grinding wheel with its axis of rotation not at right angles to the edge of the doctor blade;
setting the grinding wheel in rotation;
moving the band beneath the grinding wheel parallel to its edge and during the manufacturing, the axis of the grinding wheel is parallel to the edge of the doctor blade.

14. A method for producing a doctor blade as in claim 3, characterized in that it comprises at least the steps of:
positioning above the band a grinding wheel with its axis of rotation not at right angles to the edge of the doctor blade;
setting the grinding wheel in rotation;
moving the band beneath the grinding wheel parallel to its edge and during the manufacturing, the axis of the grinding wheel is inclined with respect to the edge of the doctor blade by an angle (α) comprised between 0° and 85°.

15. A method as in claim 14, characterised in that, during the manufacturing, the axis of the grinding wheel is inclined with respect to the edge of the doctor blade by an angle (α) comprised between 0° and 45°.

16. A method as in claim 10, characterised in that, during the manufacturing, the edge of the doctor blade is maintained on the vertical drawn from the centre of the grinding wheel.

17. A method as in claim 10, characterised in that, during manufacturing, the edge of the doctor blade is offset with respect to the vertical drawn from the centre of the grinding wheel.

18. A method as in claim 17, wherein the grinding wheel is a disk grinding wheel with a radius (r) and axis of rotation parallel to the edge of the doctor blade, characterised in that the offset (d) of the edge of the doctor blade with respect to the vertical drawn from the centre of the grinding wheel is comprised between 0 and 0.05*r.

19. A method as in claim 18, characterised in that the offset (d) of the edge of the doctor blade with respect to the vertical drawn from the centre of the grinding wheel is d=0.03*r.

20. A method for producing a doctor blade as in claim 9 characterized in that, it comprises at least the steps of:
positioning above the band a grinding wheel with its axis of rotation not at right angles to the edge of the doctor blade;
setting the grinding wheel in rotation:
moving the band beneath the grinding wheel parallel to its edge and during the manufacturing, the axis of the grinding wheel is inclined with respect to the edge of the doctor blade by an angle (α) comprised between 0° and 85° by means of a disk grinding wheel having a thickness (l), characterised in that the width (p) of the flat portion of the lamella is:
p=0.5*l*sen α if d=0;
p=l*sen α if d=0.5*l.
